(19) United States
(12) Patent Application Publication
(10) Pub. No.: US 2023/0171665 A1
(43) Pub. Date: Jun. 1, 2023

(54) METHOD AND APPARATUS FOR L1 CHANNEL STATE BASED CONDITIONAL HANDOVER

(71) Applicant: Samsung Electronics Co., Ltd., Suwon-si (KR)

(72) Inventor: Kyeongin Jeong, Allen, TX (US)

(21) Appl. No.: 18/058,254

(22) Filed: Nov. 22, 2022

Related U.S. Application Data
(60) Provisional application No. 63/284,472, filed on Nov. 30, 2021.

(51) Int. Cl. H04W 36/30; H04B 7/06; H04W 36/00

(52) U.S. Cl. CPC H04W 36/30; H04B 7/0626; H04W 36/0058

(57) ABSTRACT

Methods and apparatuses for an L1 channel state/quality based CHO in a wireless communication system. A method of a UE comprises: receiving configuration information for a CHO; generating a CSI report indicating that a channel state associated with a candidate cell is better than a channel state associated with a serving cell; transmitting the CSI report; determining, based on the CSI report transmitted, whether a value of a counter reaches a number of reporting times N for the CHO; and executing the CHO based on a determination that the value of the counter reaches the number of reporting times N for the CHO.

### CROSS-REFERENCE TO RELATED APPLICATIONS AND CLAIM OF PRIORITY

The present application claims priority to U.S. Provisional Patent Application No. 63/284,472, filed on Nov. 30, 2021. The contents of the above-identified patent documents are incorporated herein by reference.

### TECHNICAL FIELD

The present disclosure relates generally to wireless communication systems and, more specifically, the present disclosure relates to a layer 1 (L1) channel state/quality based a conditional handover (CHO) in a wireless communication system.

### BACKGROUND

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

The present disclosure relates to wireless communication systems and, more specifically, the present disclosure relates to an L1 channel state/quality based a CHO in a wireless communication system.

In one embodiment, a user equipment (UE) in a wireless communication system is provided. The UE comprises a transceiver configured to receive configuration information for a CHO and a processor operably coupled to the transceiver, the processor configured to generate a channel state information (CSI) report indicating that a channel state associated with a candidate cell is better than a channel state associated with a serving cell. The transceiver of the UE is further configured to transmit the CSI report and the processor of the UE is further configured to: determine, based on the CSI report transmitted, whether a value of a counter reaches a number of reporting times N for the CHO, and execute the CHO based on a determination that the value of the counter reaches the number of reporting times N for the CHO.

In another embodiment, a base station (BS) in a wireless communication system is provided. The BS comprises a transceiver configured to transmit configuration information for a CHO and receive a CSI report indicating that a channel state associated with a candidate cell is better than a channel state associated with a serving cell. The BS further comprises a processor operably coupled to the transceiver, the processor configured to execute the CHO based on the CSI report that is used to determine whether a value of a counter reaches a number of reporting times N for the CHO.

In yet another embodiment, a method of a UE in a wireless communication system is provided. The method comprises: receiving configuration information for a CHO; generating a CSI report indicating that a channel state associated with a candidate cell is better than a channel state associated with a serving cell; transmitting the CSI report; determining, based on the CSI report transmitted, whether a value of a counter reaches a number of reporting times N for the CHO; and executing the CHO based on a determination that the value of the counter reaches the number of reporting times N for the CHO.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example of wireless network according to embodiments of the present disclosure;

FIG. 2 illustrates an example of gNB according to embodiments of the present disclosure;

FIG. 3 illustrates an example of UE according to embodiments of the present disclosure;

FIGS. 4 and 5 illustrate example of wireless transmit and receive paths according to this disclosure;

FIG. 6 illustrates a signaling flow for an L1 channel state/quality based CHO according to embodiments of the present disclosure;

FIGS. 7A and 7B illustrate a signaling flow for a CHO mechanism according to embodiments of the present disclosure; and

FIG. 8 illustrates a flowchart of method for an L1 channel state/quality based CHO according to embodiments of the present disclosure.

### DETAILED DESCRIPTION

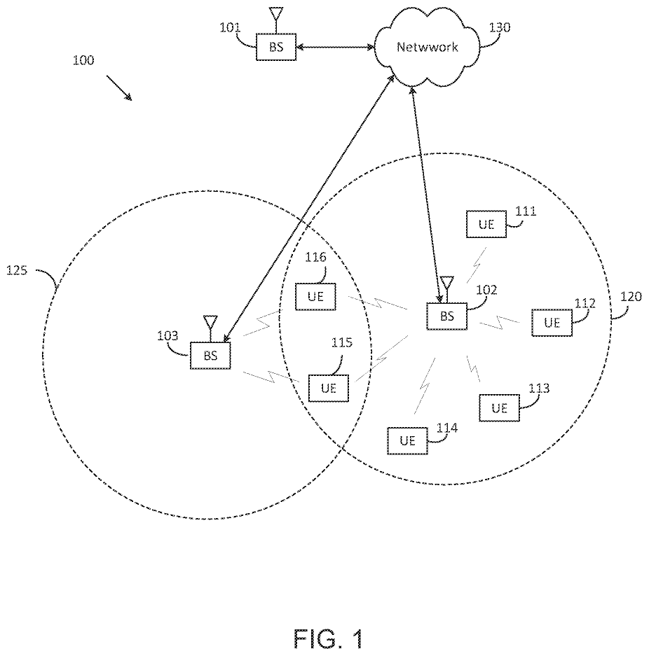

FIGS. 1 through 8, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The following documents are hereby incorporated by reference into the present disclosure as if fully set forth herein: 3GPP TS 38.321 v17.0.0, “NR; Medium Access Control (MAC) protocol specification”; and 3GPP TS 38.331 v17.0.0, “NR; Radio Resource Control (RRC) Protocol Specification.”

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for an L1 channel state/quality based a CHO in a wireless communication system In certain embodiments, and one or more of the gNBs 101-103 includes circuitry, programing, or a combination thereof, for an L1 channel state/quality based a CHO in a wireless communication system in a wireless communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

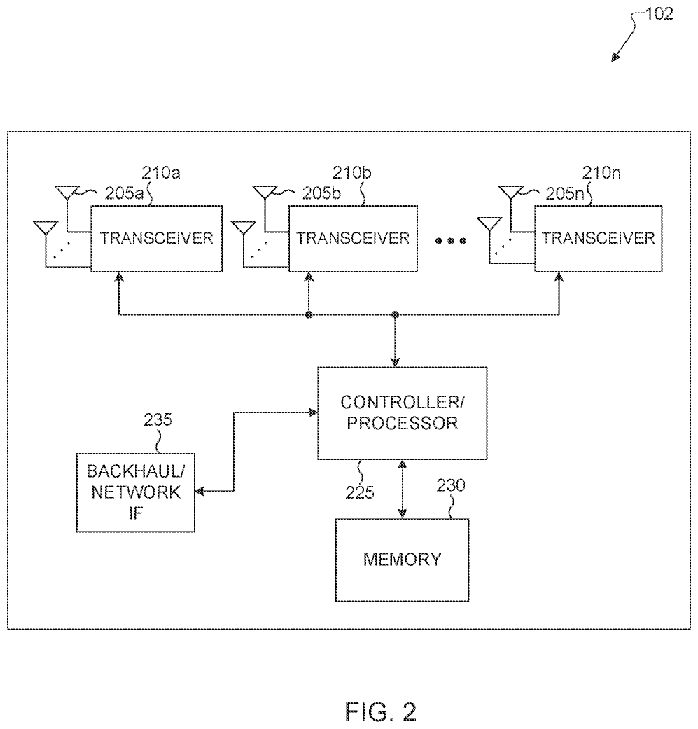

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as processes for an L1 channel state/quality based a CHO in a wireless communication system. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network.

The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

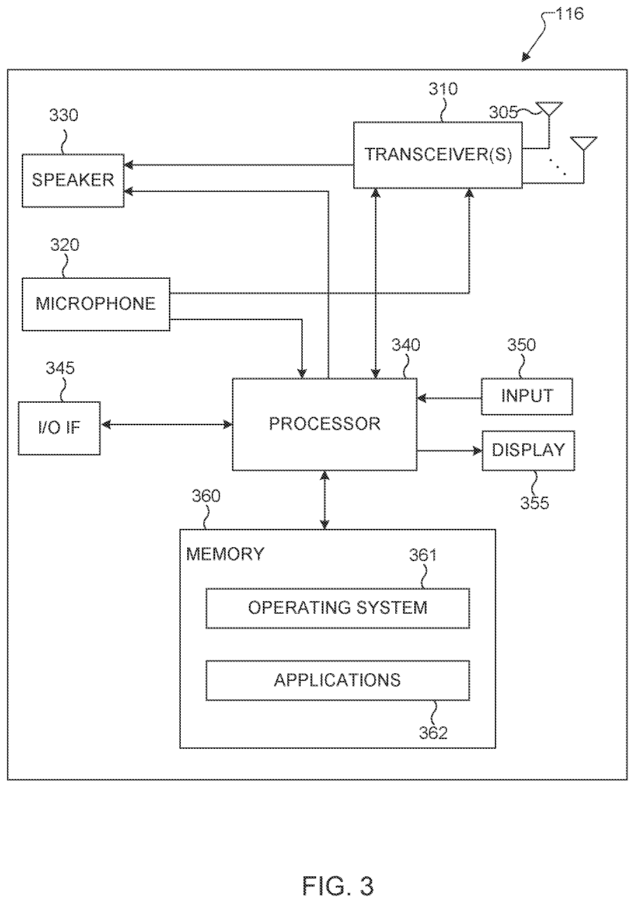

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives, from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, such as processes for an L1 channel state/quality based a CHO in a wireless communication system. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350 and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

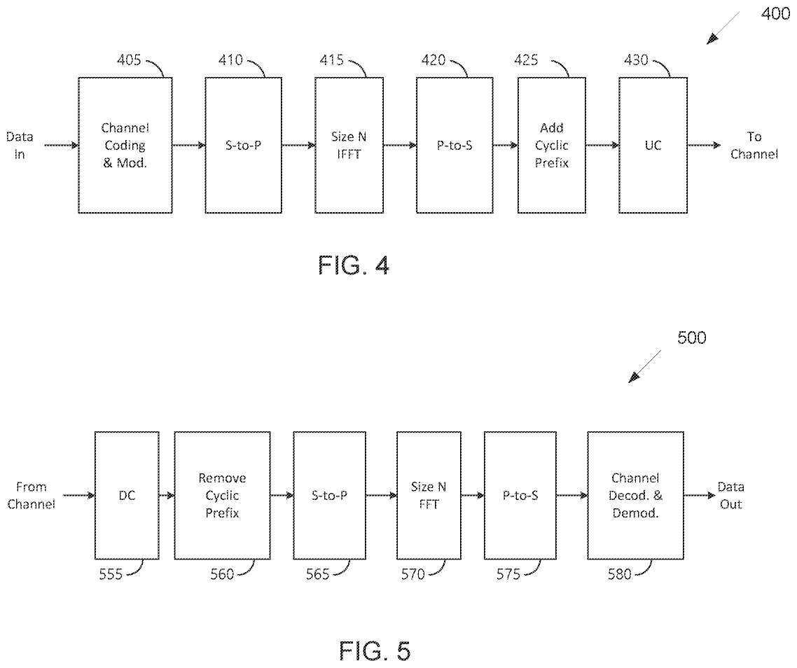

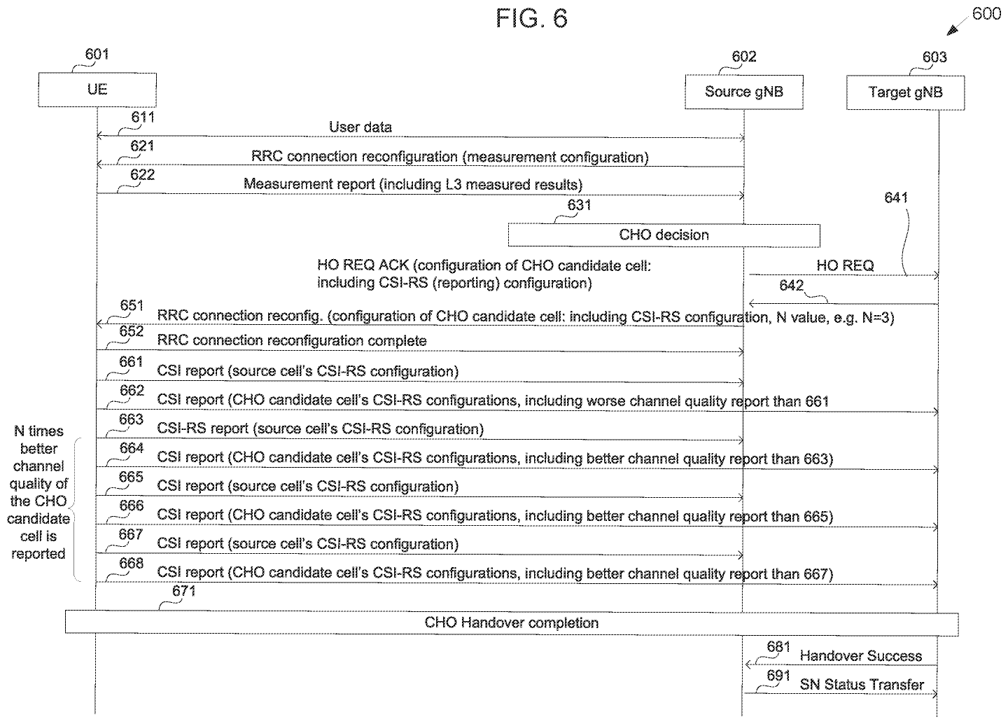

FIG. 4 and FIG. 5 illustrate example wireless transmit and receive paths according to this disclosure. In the following description, a transmit path 400 may be described as being implemented in a gNB (such as the gNB 102), while a receive path 500 may be described as being implemented in a UE (such as a UE 116). However, it may be understood that the receive path 500 can be implemented in a gNB and that the transmit path 400 can be implemented in a UE. In some embodiments, the receive path 500 is configured to support the codebook design and structure for systems having 2D antenna arrays as described in embodiments of the present disclosure.

The transmit path 400 as illustrated in FIG. 4 includes a channel coding and modulation block 405, a serial-to-parallel (S-to-P) block 410, a size N inverse fast Fourier transform (IFFT) block 415, a parallel-to-serial (P-to-S) block 420, an add cyclic prefix block 425, and an up-converter (UC) 430. The receive path 500 as illustrated in FIG. 5 includes a down-converter (DC) 555, a remove cyclic prefix block 560, a serial-to-parallel (S-to-P) block 565, a size N fast Fourier transform (FFT) block 570, a parallel-to-serial (P-to-S) block 575, and a channel decoding and demodulation block 580.

As illustrated in FIG. 4, the channel coding and modulation block 405 receives a set of information bits, applies coding (such as a low-density parity check (LDPC) coding), and modulates the input bits (such as with quadrature phase shift keying (QPSK) or quadrature amplitude modulation (QAM)) to generate a sequence of frequency-domain modulation symbols.

The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116.

As illustrated in FIG. 5, the downconverter 555 down-converts the received signal to a baseband frequency, and the remove cyclic prefix block 560 removes the cyclic prefix to generate a serial time-domain baseband signal. The serial-to-parallel block 565 converts the time-domain baseband signal to parallel time domain signals. The size N FFT block 570 performs an FFT algorithm to generate N parallel frequency-domain signals. The parallel-to-serial block 575 converts the parallel frequency-domain signals to a sequence of modulated data symbols. The channel decoding and demodulation block 580 demodulates and decodes the modulated symbols to recover the original input data stream.

Each of the gNBs 101-103 may implement a transmit path 400 as illustrated in FIG. 4 that is analogous to transmitting in the downlink to UEs 111-116 and may implement a receive path 500 as illustrated in FIG. 5 that is analogous to receiving in the uplink from UEs 111-116. Similarly, each of UEs 111-116 may implement the transmit path 400 for transmitting in the uplink to the gNBs 101-103 and may implement the receive path 500 for receiving in the downlink from the gNBs 101-103.

Each of the components in FIG. 4 and FIG. 5 can be implemented using only hardware or using a combination of hardware and software/firmware. As a particular example, at least some of the components in FIG. 4 and FIG. 5 may be implemented in software, while other components may be implemented by configurable hardware or a mixture of software and configurable hardware. For instance, the FFT block 570 and the IFFT block 515 may be implemented as configurable software algorithms, where the value of size N may be modified according to the implementation.

Furthermore, although described as using FFT and IFFT, this is by way of illustration only and may not be construed to limit the scope of this disclosure. Other types of transforms, such as discrete Fourier transform (DFT) and inverse discrete Fourier transform (IDFT) functions, can be used. It may be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIG. 4 and FIG. 5 illustrate examples of wireless transmit and receive paths, various changes may be made to FIG. 4 and FIG. 5. For example, various components in FIG. 4 and FIG. 5 can be combined, further subdivided, or omitted and additional components can be added according to particular needs. Also, FIG. 4 and FIG. 5 are meant to illustrate examples of the types of transmit and receive paths that can be used in a wireless network. Any other suitable architectures can be used to support wireless communications in a wireless network.

The 3GPP has developed technical specifications and standards to define the new 5G radio-access technology, known as 5G new radio (NR). Mobility handling is a critical aspect in any mobile communication system including 5G system. For a UE in connected mode, mobility is controlled by the network with the assistance from the UE to maintain a good quality of connection. Based on the measurement on radio link quality of the serving cell and neighboring cell(s) reported by the UE, the network may handover (HO) the UE to a neighboring cell that can provide better radio conditions when the UE is experiencing a degraded connection to the serving cell.

In release-15 NR, the basic mechanism and procedure of network-controlled mobility in connected mode is developed. In release-16 NR, enhancements to network-controlled mobility in connected mode are introduced to mitigate connection interruption during handover procedure. Specifically, two enhanced handover mechanisms are developed, known as conditional handover (CHO) and dual active protocol stack (DAPS). In traditional HO and enhanced HO (CHO and DAPS), layer 3 (L3) measurement results are included in the UE's measurement report, and they are used for the gNB to determine whether to hand over the UE to the new target cell.

In release 18, in order to reduce HO delay and service interruption time more, using L1 measurement results in HO determination is under the discussion as a release 18 work item. If we use L1 measurement results in CHO execution, it may bring more frequent CHOs since CHO execution may be done only based on the latest L1 measurement result. Note currently measurement filtering considering both the latest L1 measurement result and the past L1 measurement result(s) is not specified. In this embodiment, a CHO mechanism using L1 measurement results and avoiding frequent CHOs is provided.

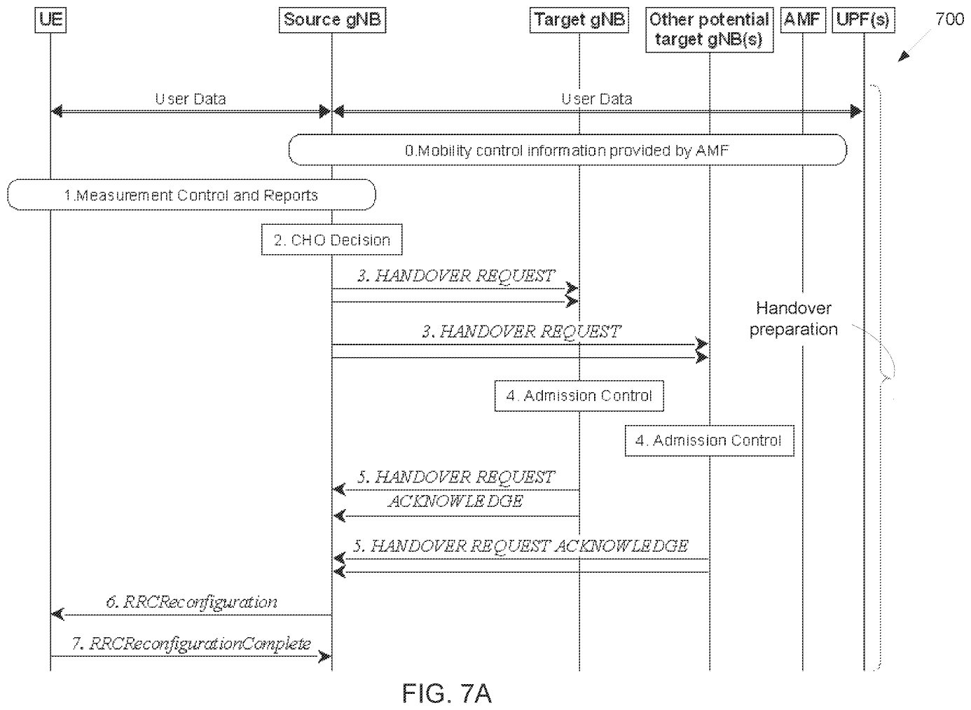

FIG. 6 illustrates a signaling flow 600 for am L1 channel state/quality based CHO according to embodiments of the present disclosure. The signaling flow 600 as may be performed by a UE (e.g., 111-116 as illustrated in FIG. 1) and a base station (e.g., 101-103 as illustrated in FIG. 1). An embodiment of the signaling flow 600 shown in FIG. 6 is for illustration only. One or more of the components illustrated in FIG. 6 can be implemented in specialized circuitry configured to perform the noted functions or one or more of the components can be implemented by one or more processors executing instructions to perform the noted functions.

FIG. 6 illustrates an example of CHO using L1 measurement report. As illustrated in FIG. 6, in step 601, a UE is indicated that the UE is in an RRC connected state. In step 602, a source gNB is indicated that the source gNB controls a UE's serving cell. In step 603, a target gNB is indicated that the target gNB controls a CHO candidate cell. In step 611, the source gNB and the UE exchanges the user data. In step 621, the source gNB configures the UE measurement procedure and in step 622, the UE sends measurement reports (including L3 filtered measured results, e.g., measured reference signal received power (RSRP) and/or (reference signal received quality (RSRQ) for the serving cell and/or neighboring cells) according to the measurement configuration.

In step 631, based on the received measurement report, the source gNB decides to use CHO. In step 641, the source gNB requests a CHO for a candidate cell belonging to the target gNB. For this instance, a CHO request message is sent for each candidate cell. In step 642, if the target gNB accepts the CHO request, the target gNB sends a CHO response (e.g., HO REQUEST ACKNOWLEDGE) including configuration information of a CHO candidate cell to the source gNB.

The configuration information of the CHO candidate cell includes a CHO candidate cell's CSI-RS configuration and/or CSI-RS reporting configuration. The CHO configuration of a candidate cell can be followed by other reconfigurations from the source gNB. The CHO response message is sent for each candidate cell. In step 651, the source gNB sends an RRCReconfiguration message to the UE, including the configuration of the CHO candidate cell and CHO execution condition. A CHO execution condition includes an N value, for example in FIG. 6, N is configured as “3.” In steps 661, 663, 665, and 667, the UE sends a CSI-RS report based on the source cell's CSI-RS (reporting) configuration. Those CSI-RS reports include channel state/quality information according to the source cell's CSI-RS (reporting) configuration.

In steps 662, 664, 666, and 668, the UE sends CSI-RS reports based on the CHO candidate cell's CSI-RS (reporting) configuration. Those CSI-RS reports include channel state/quality information according to the CHO candidate cell's CSI-RS (reporting) configuration.

It may be assumed that, in step 662, a CSI-RS report includes worse channel state/quality report than the one included for the source cell in step 661. It may be also assumed that, in steps 664, 666, and 668, the CSI-RS reports include better channel state/quality report than the one included for the source cell in step 663, 665, and 667. The UE counts number of times CSI-RS report for the CHO candidate cell (based on the CHO candidate cell's CSI-RS (reporting) configuration) includes better channel state/quality report than the CSI-RS report for the source cell (based on the source cell's CSI-RS (reporting) configuration).

In step 671, if the consecutive number of times is equal to (or larger than) the N value, the UE determines the CHO execution condition is satisfied so that the UE may apply the stored corresponding configuration for the selected CHO candidate cell and complete the RRC handover procedure by sending RRCReconfigurationComplete message to the target gNB.

Unless the consecutive number of times is equal to (or larger than) the N value, the UE determines the CHO execution condition is not satisfied, so that the UE may stay in the source cell and the CHO handover completion procedure is not triggered. As illustrated in FIG. 6, since the N value is assumed as “3,” consecutive steps 664, 666, and 668, three CSI-RS reports for the CHO candidate cell includes better channel state/quality report than the one for the source cell in steps 663, 665, and 667 meets the CHO execution condition.

In step 681, the target gNB sends a HANDOVER SUCCESS message to the source gNB to inform that the UE has successfully accessed the target cell. In step 691, the source gNB sends the SN STATUS TRANSFER message to the target gNB. Although consecutive N times is described as one example in FIG. 6, one alternative way is M can be also configured in addition to N in step 651. Then if the number of times is equal to (or larger than) the N value out of M times regardless of whether N is in consecutive or not, the UE determines that the CHO execution condition is satisfied so that the UE may apply the stored corresponding configuration for the selected CHO candidate cell and completes the RRC handover procedure by sending RRCReconfigurationComplete message to the target gNB.

Otherwise, the UE stays in the source cell and the CHO handover completion procedure is not triggered. Although CSI-RS report for the CHO candidate cell is sent to the target gNB as one example in FIG. 6, one alternative way is a CSI-RS report for the CHO candidate cell can be also sent to the source gNB in some scenarios.

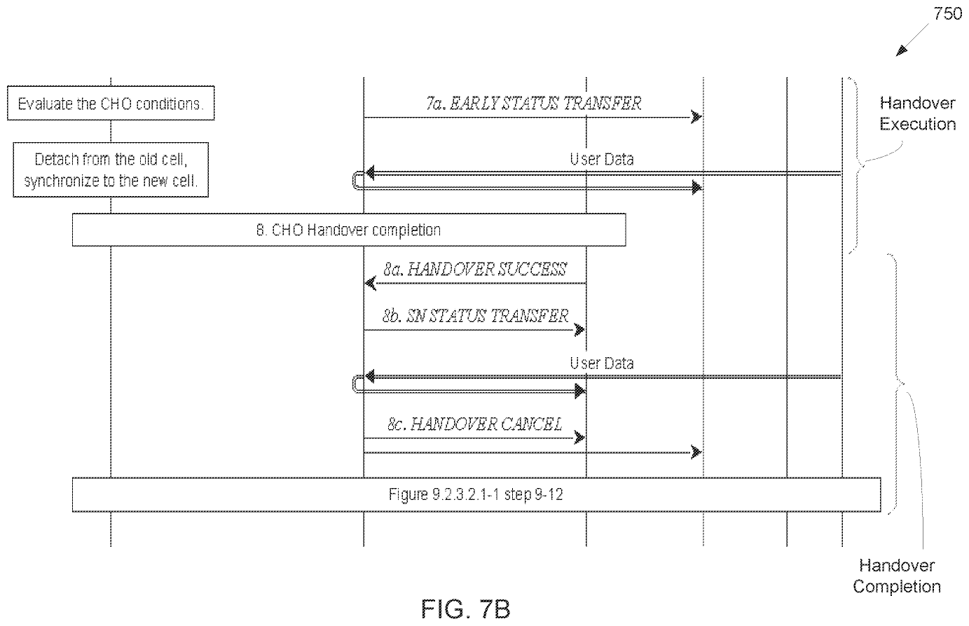

FIGS. 7A and 7B illustrates a signaling flow 700 for a CHO mechanism according to embodiments of the present disclosure. The signaling flow 700 as may be performed by a UE (e.g., 111-116 as illustrated in FIG. 1) and a base station (e.g., 101-103 as illustrated in FIG. 1). An embodiment of the signaling flow 700 shown in FIG. 7 is for illustration only. One or more of the components illustrated in FIG. 7 can be implemented in specialized circuitry configured to perform the noted functions or one or more of the components can be implemented by one or more processors executing instructions to perform the noted functions.

FIGS. 7A and 7B describe an example of release-16 CHO mechanism (basic conditional handover scenario where neither the AMF nor the UPF changes). As in intra-NR RAN handover, in intra-NR RAN CHO, the preparation and execution phase of the conditional handover procedure is performed without involvement of the 5GC; i.e., preparation messages are directly exchanged between gNBs. The release of the resources at the source gNB during the conditional handover completion phase is triggered by the target gNB.

As illustrated in FIG. 7B, FIG. 7B is connected to FIG. 7A to perform the CHO mechanism. A UE context within the source gNB contains information regarding roaming and access restrictions which were provided either at connection establishment or at the last TA update.

As illustrated in FIG. 7A, in step 1, a source gNB configures the UE measurement procedures and a UE reports according to the measurement configuration. In step 2, the source gNB decides to use CHO. In step 3, the source gNB requests CHO for one or more candidate cells belonging to one or more candidate gNBs. A CHO request message is sent for each candidate cell.

In step 4, a target gNB performs an admission control as described in 3GPP standard specification. The candidate gNB(s) sends CHO response (HO REQUEST ACKNOWLEDGE) including configuration of CHO candidate cell(s) to the source gNB. The CHO response message is sent for each candidate cell.

In step 5, the target gNB (and other target gNBs) sends a handover request acknowledgement to the source gNB. In step 6, the source gNB sends an RRCReconfiguration message to the UE, containing the configuration of CHO candidate cell(s) and CHO execution condition(s). In such steps, a CHO configuration of candidate cells can be followed by other reconfiguration from the source gNB, and a configuration of a CHO candidate cell cannot contain a DAPS handover configuration.

In step 7, the UE sends an RRCReconfigurationComplete message to the source gNB.

As illustrated in FIG. 7B, if early data forwarding is applied, the source gNB sends the EARLY STATUS TRANSFER message.

In step 8, the UE maintains connection with the source gNB after receiving CHO configuration, and starts evaluating the CHO execution conditions for the candidate cell(s). If at least one CHO candidate cell satisfies the corresponding CHO execution condition, the UE detaches from the source gNB, applies the stored corresponding configuration for that selected candidate cell, synchronizes to that candidate cell and completes the RRC handover procedure by sending RRCReconfigurationComplete message to the target gNB. The UE releases stored CHO configurations after successful completion of RRC handover procedure.

In steps 8a and 8b, the target gNB sends the HANDOVER SUCCESS message to the source gNB to inform that the UE has successfully accessed the target cell. In return, the source gNB sends the SN STATUS TRANSFER message following the principles described in step 7 of intra-AMF/UPF handover as described in 3GPP standard specification. In such step, a late data forwarding may be initiated as soon as the source gNB receives the HANDOVER SUCCESS message.

In step 8c, the source gNB sends the HANDOVER CANCEL message toward the other signaling connections or other candidate target gNBs, if any, to cancel CHO for the UE.

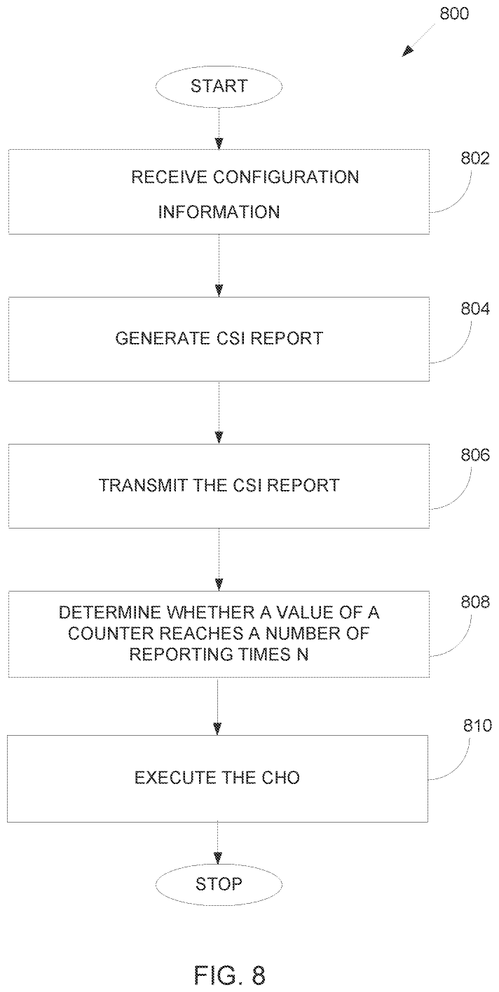

FIG. 8 illustrates a flowchart of method 800 of UE for an L1 channel state/quality based CHO according to embodiments of the present disclosure. The method 800 as may be performed by a UE (e.g., 111-116 as illustrated in FIG. 1). An embodiment of the method 800 shown in FIG. 8 is for illustration only. One or more of the components illustrated in FIG. 8 can be implemented in specialized circuitry configured to perform the noted functions or one or more of the components can be implemented by one or more processors executing instructions to perform the noted functions.

As illustrated in FIG. 8, the method 800 begins at step 802. In step 802, a UE receives configuration information for a CHO.

Subsequently, the UE in step 804 generates a CSI report indicating that a channel state associated with a candidate cell is better than a channel state associated with a serving cell.

Subsequently, the UE in step 806 transmits the CSI report.

Next, the UE in step 808 determines, based on the CSI report transmitted, whether a value of a counter reaches a number of reporting times N for the CHO.

Finally, the UE in step 810 executes the CHO based on a determination that the value of the counter reaches the number of reporting times N for the CHO.

In one embodiment, the UE increases the value of the counter by one when the CSI report is transmitted to the candidate cell.

In one embodiment, the UE resets the value of the counter when the UE transmits the CSI report indicating that the channel state associated with the serving cell is better than the channel state associated with candidate cell, before the value of the counter reaches the number of reporting times N.

In one embodiment, the UE executes the CHO when the CSI report is consecutively transmitted the number of reporting times N or identifies boundary value M for determining the number of reporting times N, the boundary value M is greater than the number of reporting times N and execute the CHO when the CSI report is transmitted the number of reporting times N out of the boundary value M.

In one embodiment, the UE receives, from a serving BS or a target BS, the configuration information including at least one of the number of reporting times N or the boundary value M via a UE dedicated RRC message.

In one embodiment, the UE identifies the channel state based on at least one of a channel information or L1 measured RSRP.

In one embodiment, the UE transmits the CSI report to a serving cell or the candidate cell when the CSI report indicates that the channel state associated with the candidate cell is better than the channel state associated with the serving cell.

In one embodiment, the UE transmits the CSI report only to the serving cell when the CSI report indicates that the channel state associated with the serving cell is better than the channel state associated with the candidate cell.

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A user equipment (UE) in a wireless communication system, the UE comprising:
a transceiver configured to receive configuration information for a conditional handover (CHO); and
a processor operably coupled to the transceiver, the processor configured to generate a channel state information (CSI) report indicating that a channel state associated with a candidate cell is better than a channel state associated with a serving cell,
wherein the transceiver is further configured to transmit the CSI report, and
wherein the processor is further configured to:
determine, based on the CSI report transmitted, whether a value of a counter reaches a number of reporting times N for the CHO, and
execute the CHO based on a determination that the value of the counter reaches the number of reporting times N for the CHO.

2. The UE of claim 1, wherein the processor is further configured to increase the value of the counter by one when the CSI report is transmitted to the candidate cell.

3. The UE of claim 1, wherein the processor is further configured to reset the value of the counter when the UE transmits the CSI report indicating that the channel state associated with the serving cell is better than the channel state associated with candidate cell, before the value of the counter reaches the number of reporting times N.

4. The UE of claim 1, wherein the processor is further configured to:
execute the CHO when the CSI report is consecutively transmitted the number of reporting times N; or
identify a boundary value M for determining the number of reporting times N, the boundary value M is greater than the number of reporting times N and execute the CHO when the CSI report is transmitted the number of reporting times N out of the boundary value M.

5. The UE of claim 4, wherein the transceiver is further configured to receive, from a serving base station (BS) or a target BS, the configuration information including at least one of the number of reporting times N or the boundary value M via a UE dedicated radio resource control (RRC) message.

6. The UE of claim 1, wherein the processor is further configured to identify the channel state based on at least one of a channel information or layer 1 (L1) measured reference signal received power (RSRP).

7. The UE of claim 1, wherein the transceiver is further configured to:
when the CSI report indicates that the channel state associated with the candidate cell is better than the channel state associated with the serving cell, transmit the CSI report to the serving cell or the candidate cell; and
when the CSI report indicates that the channel state associated with the serving cell is better than the channel state associated with the candidate cell, transmit the CSI report only to the serving cell.

8. A base station (BS) in a wireless communication system, the BS comprising:
a transceiver configured to:
transmit configuration information for a conditional handover (CHO), and
receive a channel state information (CSI) report indicating that a channel state associated with a candidate cell is better than a channel state associated with a serving cell; and
a processor operably coupled to the transceiver, the processor configured to execute the CHO based on the CSI report that is used to determine whether a value of a counter reaches a number of reporting times N for the CHO.

9. The BS of claim 8, wherein the transceiver is further configured to transmit, to the UE, the configuration information including at least one of the number of reporting times N or a boundary value M via a UE dedicated radio resource control (RRC) message.

10. The BS of claim 8, wherein the transceiver is further configured to receive the CSI report during receiving the CSI report indicating a better channel state and signal quality associated with the serving cell.

11. The BS of claim 8, wherein the channel state is determined based on at least one of a channel information or layer 1 (L1) measured reference signal received power (RSRP).

12. The BS of claim 8, wherein the processor is further configured to execute the CHO when the CSI report is consecutively received the number of reporting times N.

13. The BS of claim 8, wherein the processor is further configured to execute the CHO when the CSI report is received a number of reporting times N.

14. A method of a user equipment (UE) in a wireless communication system, the method comprising:
receiving configuration information for a conditional handover (CHO);
generating a channel state information (CSI) report indicating that a channel state associated with a candidate cell is better than a channel state associated with a serving cell;
transmitting the CSI report;
determining, based on the CSI report transmitted, whether a value of a counter reaches a number of reporting times N for the CHO; and
executing the CHO based on a determination that the value of the counter reaches the number of reporting times N for the CHO.

15. The method of claim 14, further comprising increasing the value of the counter by one when the CSI report is transmitted to the candidate cell.

16. The method of claim 14, further comprising resetting the value of the counter when the UE transmits the CSI report indicating that the channel state associated with the serving cell is better than the channel state associated with candidate cell, before the value of the counter reaches the number of reporting times N.

17. The method of claim 14, further comprising:
executing the CHO when the CSI report is consecutively transmitted the number of reporting times N; or
identifying a boundary value M for determining the number of reporting times N, the boundary value M is greater than the number of reporting times N and executing the CHO when the CSI report is transmitted the number of reporting times N out of the boundary value M.

18. The method of claim 17, further comprising receiving, from a serving base station (BS) or a target BS, the configuration information including at least one of the number of reporting times N or the boundary value M via a UE dedicated radio resource control (RRC) message.

19. The method of claim 14, further comprising identifying the channel state based on at least one of a channel information or layer 1 (L1) measured reference signal received power (RSRP).

20. The method of claim 14, further comprising:
when the CSI report indicates that the channel state associated with the candidate cell is better than the channel state associated with the serving cell, transmitting the CSI report to the serving cell or the candidate cell; and
when the CSI report indicates that the channel state associated with the serving cell is better than the channel state associated with the candidate cell, transmitting the CSI report only to the serving cell.
